(19) United States
(12) Patent Application Publication
(10) Pub. No.: US 2007/0245882 A1
(43) Pub. Date: Oct. 25, 2007

(54) Interactive computerized digital media management system and method

(76) Inventor: Michael J. Odenwald, Pipersville, PA (US)

Correspondence Address: Louis M. Heidelberger, Esq.;Reed Smith, LLP, P.O. Box 7990, Philadelphia, PA, 19101, US

(21) Appl. No.: 11/486,401

(22) Filed: Jul. 12, 2006

Related U.S. Application Data
(63) Continuation-in-part of application No. 11/397,322, filed on Apr. 4, 2006.

(51) Int. Cl. G10H 7/00

(52) U.S. Cl. 84/609

(57) ABSTRACT

A system and method for managing digital media data files owned by a user via a network are disclosed. The system and method include at least one processor and at least one database, communicatively connected to the at least one processor, for storing at least one data file, and at least one computing device, remote from the at least one processor and communicatively connected to the at least one processor via a network. The at least one computing device is capable of uploading the at least one data file and subsequently accessing selected ones of the at least one data file, where the user provides a first information item relating to the at least one computing device to the at least one processor. The system and method also include at least one information provider, remote from the at least one processor and communicatively connected to the at least one processor via the network, wherein the at least one information provider provides a second information item relating to the at least one computing device and based on the first information to the at least one processor, where the at least one processor manages the access to the selected ones of the at least one data file by the at least one computing device based on the first and second information items. The system and method also include at least one interactive visual interface wherein said user may, in real-time and in conjunction with the system and method, manage and view at least one selected from the group consisting of: user's said digital media files, said data files, said information items, and combinations thereof.

### RELATED APPLICATIONS

This application is a continuation-in-part of U.S. patent application Ser. No. 11/397,322, filed on Apr. 4, 2006, the entire disclosure of which is incorporated by reference herein, as if being set forth in its entirety.

### FIELD OF THE INVENTION

The invention relates to a real-time, computerized platform for managing digital media collections and to a system and method for improved storage, management, and delivery of digital media files via a global network from both local and remote locations.

### BACKGROUND OF THE INVENTION

Currently, there are a variety of media play applications available for playing and organizing digital media files. These applications typically interface with a handheld device, such as a digital audio player, or other various computing devices containing programming to manage and play digital music files. Such applications may also include connections to on-line stores to allow users to purchase digital media, such as music files, that can be played by a handheld device in conjunction with the applications. Some applications profess a reputation for being easy to use and for having enhanced user interfaces, while continuing to provide many features for obtaining, organizing, and playing music. The applications are sometimes free to download from the internet and may be bundled with the computer's or hand-held device's software. Many such applications are compatible with standard forms of computer operating systems, including Mac OS X, Windows® 2000, Windows® XP, and Windows® Server 2003.

Currently, users may add music files to the application from existing compact discs, music files residing on a computer, or by purchasing and downloading music files over the internet. Some applications can organize music files by artist, theme, category, date, or other characteristic of music. In certain instances, when more than one music file has been added to an application, an application may allow users to create music libraries and manage the music files therein. For example, some applications allow users to manage music files by creating a list of music files (or playlist), adjusting random playback of songs, and/or setting parental controls. In addition, some applications have features which allow users to edit the music's file information, record compact discs, copy the music files to a digital audio player, or run a visualizer to display graphical effects in time to the music being played, as well as encode music into a number of different audio formats.

Many current applications have different playback features, which may be customizable by the user. In many cases, users can create playlists according to their own preferences, which can be saved and then played immediately or at a later time. In other cases, some applications' playlist-creation function can be set to automatically update like a database query, based on a customized list of selection criteria. Users can enter different criteria to control different aspects of the playlist, such as the artist or genre of the music. Some applications allow users to choose from a selection of playback modes, including by playlist, by artist, or by genre playback, for example. Additionally, some applications may allow users to choose between random or sequential playback. In such cases, applications allow for the “randomness” of the playback function to be biased for or against playing multiple songs from the same album or artists in sequence or to select songs randomly from other playlists, or from the library.

Some applications allow synchronization of hand-held devices with music file content (such as music libraries and playlists) on various forms of computers. In this case, new songs and playlists may be automatically copied to the hand-held device, and songs which have been deleted from the library on the computer may also be deleted from the hand-held device. In some instances, applications allow automatic synchronization to be turned off in favor of manually copying individual music files or complete playlists.

However, as society produces more and more kinds of electronic device capabilities, a need for electronic device consolidation has pushed many of the features of hand-held devices, such as calling, emailing, paging, and/or other networked functions into “all in one” devices. Because of this, devices such as wireless phones, which can also play music and connect to the internet, are fast becoming the preferred hand-held device, at the expense of simple music players. This movement to “all in one” wireless phones also creates a premium for storage space which, will typically be used primarily for storing programming and other data necessary for functionality resident on the device. Currently, cellular telephones have the capabilities of storing limited amounts of files, displaying (in black and white or color) pictures and text, connecting to the internet, and playing music. Designers of multifunctional wireless phones are also incentivized to keep resident storage space down, as use of large amounts of resident storage and the programming surrounding such use may cause the phone to constantly run hot and thus create functional problems from overheating, or may cause excessive battery use and, thus, undesired shorter change direction.

Because the aforementioned media player applications require large amounts of storage resident on the hand-held device, these applications, and the music management systems surrounding such applications, are quickly becoming obsolete. Also, while some cellular phones are capable of holding a limited number of music files, no system presently exists for providing an immediate, continuous, and visual link to a user's full collection of music files on multiple devices concurrently. Thus, a need exists to combine the capabilities of a hand-held digital media player with the capabilities of a cellular phone and a desktop computer in such a way that only one device is needed to both communicate and access and manage a large collection of music files. Furthermore, currently no computerized, interactive systems or methods exist in which the content on handheld devices, cellular phones, and/or other forms of devices including, but not limited to, desktop personal computers and/or laptops, may be controlled and managed, as well as combined with other applications. Thus, a need exists for such a computerized, interactive system or method which allows a user to visually manage his or her media collection residing on one or more devices in such a way as to allow the user to change, manage, share, manipulate, and receive more info on the content on any of his or her devices in such a manner that is easy to use, visually pleasing, real-time, customizable, interactive, and fun to use.

### SUMMARY OF THE INVENTION

The present invention described includes a real-time, interactive, computerized system and method for managing digital media data files owned by a user via a network and providing a host of customizable features and applications related to the user's digital media data files that are visual, interactive, and speech/voice-enabled. The system and method include at least one processor and at least one database, communicatively connected to the at least one processor, for storing at least one data file, and at least one computing device, remote from the at least one processor and communicatively connected to the at least one processor via a network. The at least one computing device is capable of uploading the at least one data file and subsequently accessing selected ones of the at least one data file, where the user provides a first information item relating to the at least one computing device to the at least one processor. The system and method also include at least one information provider, remote from the at least one processor and communicatively connected to the at least one processor via the network, wherein the at least one information provider provides a second information item relating to the at least one computing device and based on the first information to the at least one processor, where the at least one processor manages the access to the selected ones of the at least one data file by the at least one computing device based on the first and second information items. The system and method also include at least one interactive visual interface wherein the user may, in real-time and in conjunction with the system and method, manage and view at least one selected from the group consisting of: user's said digital media files, said data files, said information items, and combinations thereof.

Also described is a system for displaying lyrics to prerecorded music during play of the prerecorded music melodies and/or lyrics, via a network. The system includes at least one processor and at least one database, communicatively connected to the at least one processor, for storing a plurality of prerecorded music files; and at least one information provider, remote from the at least one processor and communicatively connected to the at least one processor via a network, where the at least one information provider provides at least lyrics corresponding to selected ones of the plurality of prerecorded music files at the request of the at least one processor, and at least one computing device, remote from the at least one processor and communicatively connected to the at least one processor via a network, where the at least one processor provides access to selected ones of the plurality of prerecorded music files and the corresponding lyrics for both playing the selected ones of the plurality of prerecorded music files and viewing the corresponding lyrics simultaneously on the at least one computing device. The system also includes at least one interactive visual interface wherein a user may, in real-time and in conjunction with the system, carry out all functions of the system.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 is a schematic diagram of the overall system components according to the present invention;

FIG. 2 is a schematic diagram of the central server of FIG. 1;

FIG. 3 is a flowchart outlining a method of managing digital media files based on the system of FIG. 1; and

FIG. 4 is a schematic diagram of a karaoke system using the method of FIG. 3.

FIG. 5 is a screenshot illustrative of an exemplary embodiment of the present invention.

FIG. 6 is a screenshot illustrative of an exemplary embodiment of the present invention.

FIG. 7 is a screenshot illustrative of an exemplary embodiment of the present invention.

FIG. 8 is a screenshot illustrative of an exemplary embodiment of the present invention.

FIG. 9 is a screenshot illustrative of an exemplary embodiment of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in digital media management systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

In an exemplary embodiment of the present invention, a computerized network may be used not only to upload digital media files to remote storage for future access, but also for distributing additional data or information relating to the uploaded digital files from a central location to any number of end-users or devices located remotely from the central location. Such files may be any sort of file suitable for containing multimedia content, such as, but not limited to, the most current versions of JPEG, MPEG, MOV, WAV, AVI, or MP3, to name just a few.

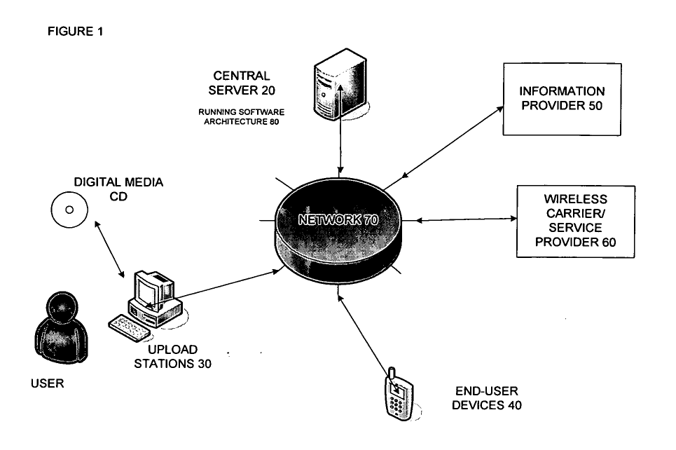

As may be seen in FIG. 1, system 10 may generally include a central server 20, upload stations 30, end-user devices 40, information providers 50, wireless carrier/service providers 60, and wide area network 70.

Central server 20 may include specialized software 80 (described below) and may be run by a system 10 administrator or administration staff, and may include at least one processor, standard input and output devices, as well as all hardware and software typically found on computing devices for storing data and running programs, and for sending and receiving data over a network. Central server 20 may be one server or, more preferably, a combination of scalable servers, providing functionality as a network mainframe server, a web server, a mail server and central database server, all maintained and managed by the system 10 administrator. Central server 20 may also be connected directly or via a network to remote databases, such as for additional storage backup. Central server 20 may be connected to any number of upload stations 30, end-user devices 40, information providers 50, and wireless carrier/service providers 60, all via a wide area network 70, such that wide area network 70 allows for the communication of files, email, software, and any other data format between central server 20 and upload stations 30, end-user devices 40, information providers 50, and wireless carrier/service providers 60. Additionally, the system administrator may add any number of servers or other necessary hardware and software to central servers 20, such that system 10 may provide efficient and reliable service for local upload stations 30 and end-user devices 40, as the number of upload stations 30 and end-user devices 40 may increase.

Upload stations 30 may be one or more of any sort of computing device suitable for uploading a digital media file to central server 20 via wide area network 70. For example, such computing device may be a personal computer (“PC”), a personal digital assistant (“PDA”), a laptop, a wireless digital/cellular phone, or the like. In an exemplary embodiment, upload station 30 may be a kiosk situated near a digital music or video retail store, or may simply be a home computer owned by the purchaser of a musical compact disc (“CD”). Upload stations 30 may also form part of or otherwise be connected to any sort of local area network such as, for example, a local wireless network within a user's home or within a retail store or office building.

End-user devices 40, like upload stations 30, may be one or more of any sort of personal digital device, such as a desktop PC, a laptop, a PDA, or, more preferably, a wireless digital/cellular phone, for example, such that end-user devices 40 may be communicatively connected to central server 20 via wide area network 70. While end-user devices 40 may also be connected to a preexisting calling network provided by one of the many existing wireless phone service providers, such multi-network connectivity should not interfere with the wireless phone's connection to system 10 via wide area network 70. It should also be understood that, while upload stations 30 and end-user devices 40 have been thus far described as separate entities, a single device may operatively function as both upload station 30 and end-user device 40 at different points in time.

Information providers 50 may provide additional information or data related to any sort of digital media that is publicly or commercially available. For example, such information or data may be song lyrics, advertisements, information about artists, complementary digital media in the form of still frame, video or audio, real-time news or updates, or any other information that may be related to particular digital media. This information or data may be in any format transferable over wide area network 70, and may be requested or accessed by central server 20 as needed or as agreed to between managers of both central server 20 and information provider 50.

For example, advertisers wanting to reach the public may first provide the central processor 20 with content in the form of a computer readable file according to a set of specifications for such files to conform to. These specifications may define a particular file format or formats that may be relatively simple for advertisers or other information providers to meet, and the process of central server 20 for incorporating the files into accessible data for user may be simplified.

Information provider 50 may also assist central server 20 in digital music identification and recognition for both compact discs and individual music files through system 10. Multi-step recognition methods may enable system 10 to identify, categorize, and/or organize stored digital music. Automated and scalable computer-based analysis of the audio waveforms of individual songs using digital signal processing techniques may objectively determine musical characteristics such as tempo, timbre, rhythm, instrumentation, harmony, melody, and/or structure of individual songs. Once music is identified, music-related information and/or content may be obtained from information provider 50. Such incorporation of information from information provider 50 may allow for the generation of recommendations for music, music videos, and other music-related merchandise that users may be interested in. The number and variety of recommendations may be tailored before they are presented to a user either by information provider 50, central server 20, or by the user of system 10.

Wireless carrier/service providers 60 may be any digital or cell phone provider that offers digital and cell phone plans to the public. Wireless carrier/service providers 60 simply need be communicatively connected to wide area network 70, such that central server 20 may request and receive information from the particular wireless phone service provider to which end-user device 40 receives phone service from. Once the particular wireless phone service provider 60 has been identified, that service provider 60 may provide information to central server 20 relating to phone type of end-user devices 40, as well as the type of calling plan used by the owner (or user) of end-user device 40.

Wide area network 70 may be any suitable networked system understood by those having ordinary skill in the art, such as, for example, an open, wide area network (e.g., the internet), an electronic network, an optical network, a wireless network, a physically secure network or virtual private network, and any combinations thereof. Wide area network 70 may also include any intermediate nodes, such as gateways, routers, bridges, internet service provider networks, public-switched telephone networks, proxy servers, firewalls, and the like, such that wide area network 70 may be suitable for the transmission of data throughout system 10.

An encryption standard may also be used to protect files from unauthorized interception over the network. Any encryption standard or authentication method as may be understood by those having ordinary skill in the art may be used at any point in system 10. For example, encryption may be accomplished by central server 20 encrypting the output file by using a Secure Socket Layer (SSL) with dual key encryption, since a high degree of security may be desired by some of the information providers, copyright owners, and users alike. Additionally, system 10 may limit, for example, data manipulation, or information access. For example, a system 10 administrator may allow for administration at one or more levels, such as at an individual user level, or at a system level. The system 10 administrator may also implement access or use restrictions for users at any level. Such restrictions may include, for example, the assignment of user names and passwords that allow the use of the present invention, or the selection of one or more data types that the subservient user is allowed to view or manipulate.

Further, wide area network 70 may also use standard architecture and protocols as understood by those skilled in the art, such as, for example, a packet switched network for transporting information and packets in accordance with a standard transmission control protocol/Internet protocol (“TCP/IP”). Central server 20, upload stations 30, end-user devices 40, information providers 50, and wireless carrier/service providers 60 may be communicatively connected into wide area network 70 through, for example, a traditional telephone service connection using a conventional modem, an integrated services digital network (“ISDN”), a cable connection including a data over cable system interface specification (“DOCSIS”) cable modem, a digital subscriber line (“DSL”), a T1 line, or any other mechanism as understood by those skilled in the art. Additionally, system 10 may utilize any conventional operating platform or combination of platforms, and may utilize any conventional networking and communications software as needed.

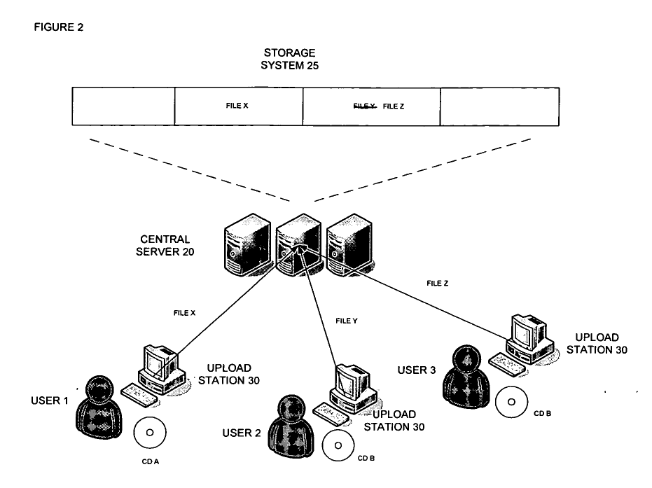

Referring now to FIG. 2, a more detailed description of central server 20 is provided. A person, such as user 1, who purchases digital media, such as a musical CD, such as “CD A”, from a retail store, for example, may use upload station 30 to upload musical CD A file in a compressed and optimal file format as determined by central server 20 and designated herein as “file X”, to central server 20. Central server 20 receives uploaded file X and stores it in a database storage system 25, a portion of which is designated as a “lock box”, holding those files owned and stored by User 1. Alternatively, central server 20 may store all digital media uploaded in a generalized master database system, and further create and manage digital media file lists for each user, such that central server 20 may recognize and match each user with their uploaded files, and allow access to only those files owned or uploaded by each particular user.

In the above described exemplary embodiment, each file uploaded may be stored separately and independently from all other uploaded files. In an alternative embodiment of central server 20, central server 20 may, prior to storing an uploaded file for a particular user, check to see if a file identical to the uploaded file has already been stored in database storage system 25. If a previous version of the uploaded file has not already been stored in database storage system 25, central server 20 may store the uploaded file for the user. If a previous version of the uploaded file was already stored in database storage system 25, central server 20 may simply designate the user uploading the file as having access to the previously stored file, and replace the old version of the stored file with the most recent copy only if deemed necessary. For example, as shown in FIG. 2, multiple users, depicted as Users 1, 2, and 3, may upload digital media, such as a musical CDs A and B, purchased at retail stores by Users 1, 2, and 3, where User 1 purchased CD A and Users 2 and 3 each purchased their own copies of CD B. Each user uploads their purchased CD at an upload station 30 at different points in time, where the CDs are compressed and uploaded sequentially to central server 20 as files X, Y and Z, representative of the CDs purchased by Users 1, 2, and 3, respectively. Assuming that User 3 is the last user to upload his or her copy of CD B, when User 3 uploads file Z (the compressed version of CD B), central server 20 recognizes that previously uploaded file Y (also a compressed version of CD B) is already stored in storage system 25, replaces stored file Y with the more recent file Z, and designates both Users 2 and 3 as having access to file Z. Central server 20 may also recognize a file designated for upload as a copy of a previously stored file prior to actual uploading, and simply give access to the previously stored file to the user. Such recognition by central server 20 prior to uploading may be based on instruction by the user, or by recognition of the file designated for upload via an encoded “tag” forming part of the file or associated with the file, or by any other mechanism understood by those skilled in the art.

Individual user accounts may be established to manage, track and to customize information or to target information or promotional material to particular users or set of users. System 10 may also include a registration system, such that, if the user has previously visited and entered and set up a user account, meaning particular information, such as an identifier, has been saved in the system, system 10 may acknowledge this fact, and simply apply information provided by the user in the previous registration. Individual email accounts may also be established via software 80, or previously existing email accounts may be associated with individual user accounts to allow system 10, information providers 50, wireless carrier/service providers 60, or other organizations participating in system 10 to send email messages to any particular user or group of users.

System 10 further includes application software 80, which may be managed by central server 20. Software 80 may include a software framework that optimizes ease of use of at least one existing software platform, and that may also extend the capabilities of at least one existing software platform. The application architecture may approximate the actual way users organize and manage digital media files, and thus may organize use activities in a natural, coherent manner while delivering use activities through a simple, consistent, and intuitive interface within each application and across applications. The architecture may also be reusable, providing plug-in capability to any number of applications, without extensive re-programming, which may enable parties outside of system 10 to create components that plug into the architecture. Thus, software or portals in the architecture may be extensible and new software or portals may be created for the architecture by any party.

Software 80 may provide, for example, applications accessible to one or more users to perform one or more functions. Such applications may be available at the same location as the user, or at a location remote from the user. Each application may provide a graphical user interface (GUI) for ease of interaction by the user with information resident in system 10. A GUI may be specific to a user, set of users, or type of user, or may be the same for all users or a selected subset of users. Software 80 may also provide a master GUI set that allows a user to select or interact with GUIs of one or more other applications, or that allows a user to simultaneously access a variety of information otherwise available through any portion of system 10.

Software 80 may be a portal that provides, via the GUI, remote access to and from the present invention. Software 80 may include, for example, a network browser, as well as a media player. Software 80 may include the ability, either automatically based upon a user request in another application, or by a user request, to “hook”, search, or otherwise retrieve particular data from one or more remote points, such as on the internet. Software 80 may vary by user type, or may be available to only a certain user types, depending on the needs of system 10. Users may have some portions, or all of software 80, resident on uploading stations 30 or end-user devices 40, or may simply have linking mechanisms, as understood by those skilled in the art, to link uploading stations 30 or end-user devices 40 to software 80 running on central server 20 via wide area network 70. As such, any device having, or having access to, the software 80 may be capable of uploading, or downloading, any media files, or informational files to be associated with such media files. In one exemplary embodiment, such linking mechanisms may be included as part of or in association with a purchased digital media file, such as an additional “non-musical” track on the music CD, so that when the music CD is loaded into uploading station 30, the user is automatically granted, or simply invited, to access software 80 resident on central server 20 of system 10. Software may also be provided separately and/or run separately on any upload station 30 or end-user device 40, providing all functionality applicable to such devices as may be appropriate until actual connection to wide area network 70 (and consequently central server 20) is achieved.

Presentation of data through software 80 may be in any sort and number of selectable formats. For example, a multi-layer format may be used, wherein additional information is available by viewing successively lower layers of presented information. Such layers may be made available by the use of drop down menus, tabbed pseudomanila folder files, or other layering techniques understood by those skilled in the art. Formats may also include AutoFill functionality, wherein data may be filled responsively to the entry of partial data in a particular field by the user. All formats may be in standard readable formats, such as XML. Software 80 may further incorporate standard features typically found in media play applications, such as, for example, a front or “main” page to present a user with various selectable options for use or organization of media files. In one exemplary embodiment, selectable buttons may permit a user to view or listen to prerecorded music, video, or even play games, for example, and choose or organize their media files based on any sort of category, such as rock, country, jazz, or pop for music files, or comedy, horror, or action, for video files. A listener may also have the option to search or browse for media by standard or customized categories. Further, software may allow other information related to their stored digital media files that may be of interest to users, and may graphically display any portion of such information either as a separate window, or by any other mechanism understood by those skilled in the art. Software 80 may also support a live streaming broadcast of uploaded songs, or any sort of “live feed” streamed to end-user device 40, such as live radio, television, real-time stock quotes, and the like. Because end-user device 40 may typically be a mobile device, such as a wireless phone, streaming data may be passed throughout wide area network 70 as needed between towers, any by any other method understood by those skilled in the art. Software 80 may also support any sort of interactive purchasing platform, where a user may receive advertisements and purchase items from system 10 or from any third party connected to system 10 via wide area network 70.

Visual interface may be rendered by any computer code and/or programs necessary and as may be understood by those of ordinary skill in art. The visual interface may have many functions, such as present information in many forms to users, act as a conduit for users and administrators to enter information into the system, display user choices for selection, graphs, photographs, pictures, drawings, charts, and/or animated content, for example. In one embodiment, the visual interface may be a secured interface, such that users must log on to such an interface through a secure portal. This may require users to have an account, which may include a log-on identity and password, for example, as may be understood by those of ordinary skill in the art. If the user is not an allowed user or registered user and/or not an administrator, the user may be prevented from accessing any further information. If the user is an allowed user and/or system administrator, then the user/administrator may access further information. Such security features of the visual interface may exist at any level of security, ranging from, for example, very restrictive of entry to the website to no restriction of entry to the website, as a user may choose or the administrator may desire and may be changed over time as the administrator and/or user sees the need.

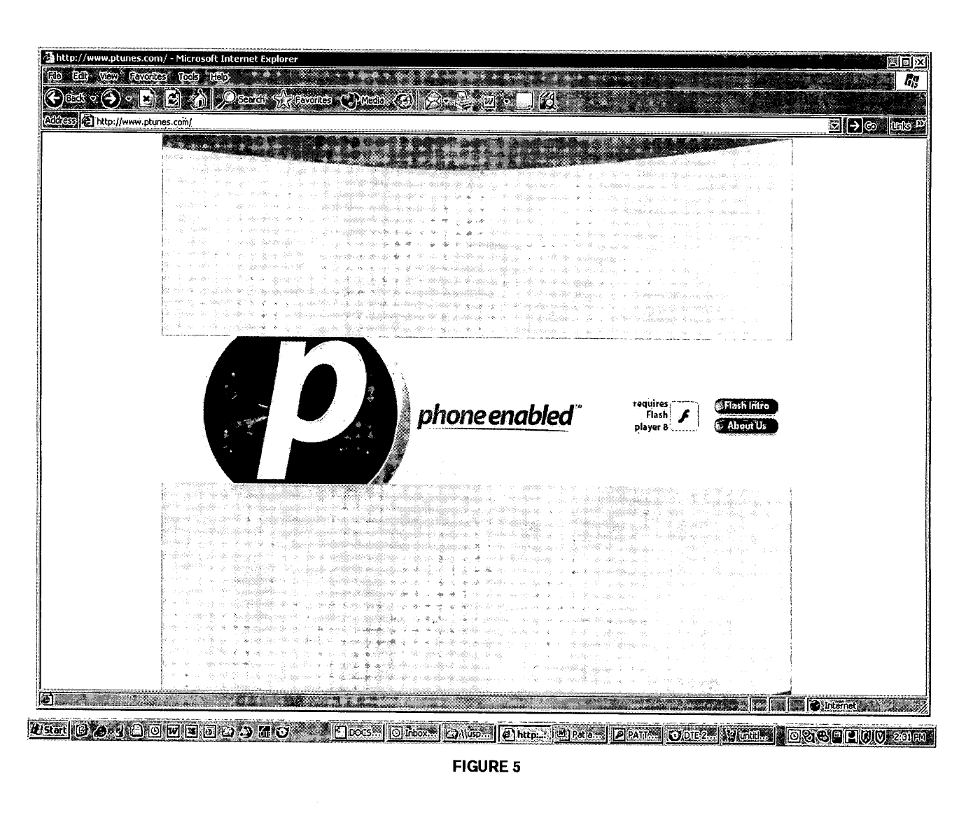

A user may, from an appropriate computing device, as described above, access the visual interface, an illustration of which may be seen in FIG. 5. In one embodiment of the present invention, a user may be required to pay for services, usage, software, and/or usage of the visual interface. The payment for usage of or content, as herein described, may include paying by the time any is used, a flat fee, a negotiated price, or any other way as may be deemed appropriate by an administrator. Such payment may be accomplished by paying via the visual interface and through changing the visual interface as may be understood by those of ordinary skill in the art of website payment transactions.

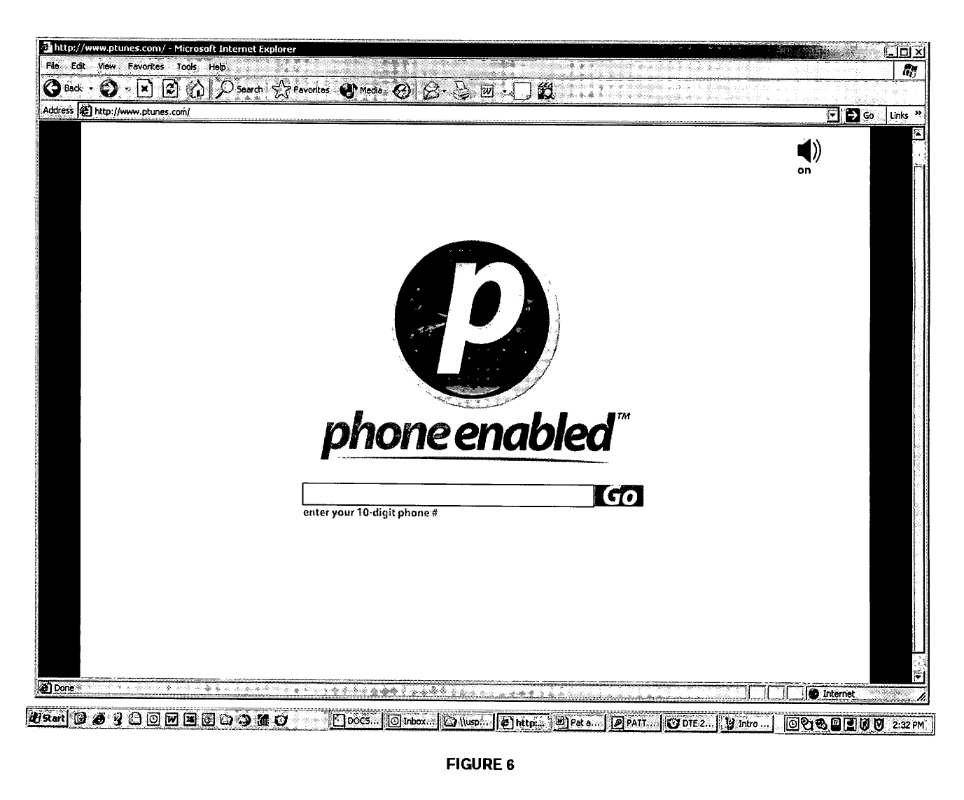

From the visual interface, as illustrated in FIG. 5, users may be directed to or select to advance to another page of the visual interface, as illustrated in FIG. 6. Such page of the visual interface may prompt a user to enter his or her cellular phone number. Such entering of a phone number may start the process of logging a user on. After a user has entered his or her phone number, a user may be identified, if they are not already identified, to determine the user's user-specific data including, but not limited to, the user's device information, digital media file information, stored information, and logon information. According to an aspect of the present invention, when a user enters a phone number, a password may be required, or other further identifier, for security purposes, as described herein above.

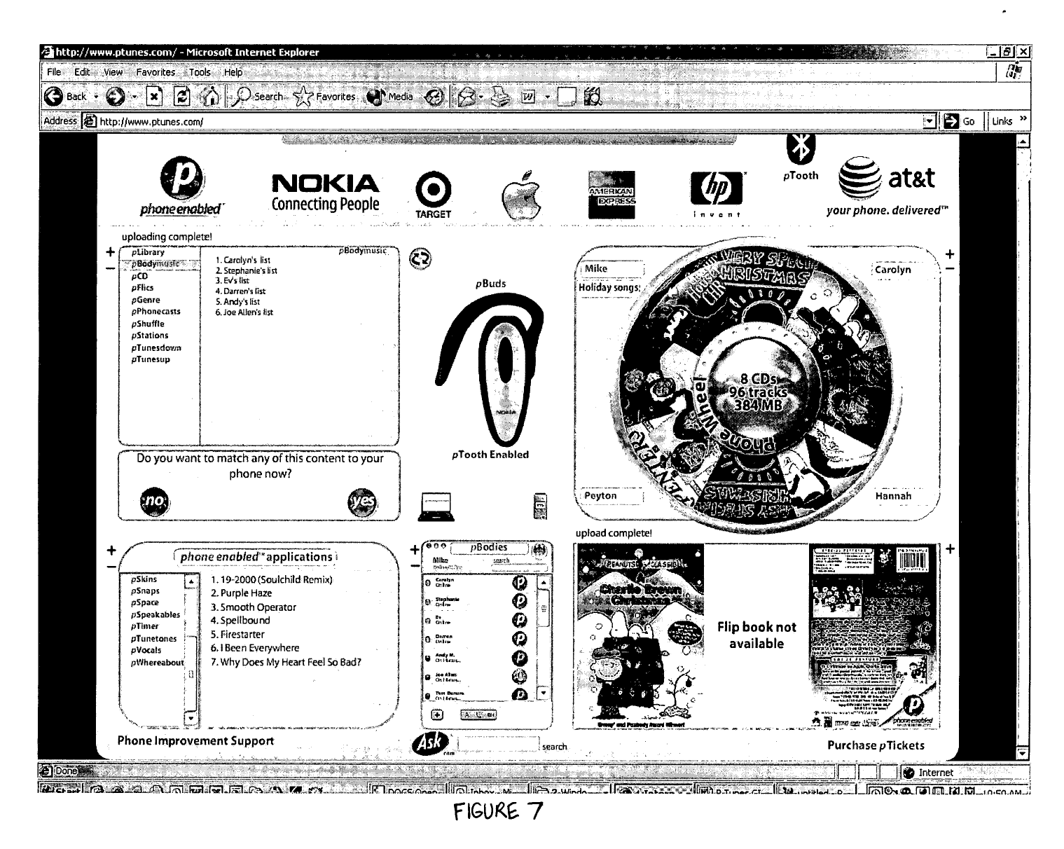

When a user enters a password or other identifier that matches that which is stored for that user, the user may be logged on and gain access to all information related to the user's personal account. The visual interface may be equipped to speak to a user, including, but not limited to, to ask a user for his or her phone number, logon identifier, or name, which may be enabled by voice-recognition, voice recording, and recording playback technologies, as one of ordinary skill in the art may understand. Alternatively, passwords or other security features may be used in lieu of a phone number, such as, for example, a user's logon name. Once a user has cleared security measures, the user may have to access capabilities, applications, and functions, including further information through the visual interface. Such capabilities, applications, and functions of the visual interface may be accessed through the visual interface as a user homepage, a part of which is illustrated in FIG. 7. The user homepage may provide a starting point for any user's interaction with all capabilities, functions, and/or applications, including any capabilities, functions, and/or applications which may be specific to a user. The administrator may offer different capabilities, functions, and/or applications at different prices or rates to a user or may sell them in package form according to the user's desires to have certain capabilities, functions, and/or applications. Thus, any particular user's user homepage may be different from another user's user homepage according to what capabilities, functions, and/or applications each user has selected to engage in. Furthermore, a user may be able to format his or her user homepage as they wish, if the administrator allows such, wherein the user may be able to only show certain capabilities, functions, and/or applications on his or her user homepage, as the user desires.

According to one aspect of the present invention, the user homepage, may have accessible and visible (as icons or pictures), to a user the following items, capabilities, functions, and/or applications, by way of non-limiting example: a user's phone number; a user's account information; a means for changing and/or selecting a user's options; help and/or support functions; selected advertisers functions; device options; data transfer options; chat room capability; digital media file sharing capabilities; picture and/or graphical viewing capabilities; digital media file information and data synching functions; digital media file categorizing and archiving functions; digital media file playing and sorting functions; digital media file creation and editing functions; karaoke functions; ticket purchasing applications; calendar applications; voice recording applications; alerting/reminding applications; user account funding functions; voice-triggering applications; phone calling applications; applications which synchronize wireless handheld devices with other user devices; search engine applications; and instant messaging applications, for example. Any number of additional features may be added and any combination of these and other features may be incorporated as desired.

According to another aspect of the present invention, a user may have a “list of friends,” such as other users/registered users who the user has allowed to connect to the user through linking account information as may be understood by those of ordinary skill in the art. For example, a first user may develop a list of friends by entering other users' names, email addresses, phone numbers, and/or other identifiers, wherein this other information may be verified with the other users that the other users want to be associated in the first user's list of friends. In another embodiment, system 500 may determine if the other users have entered the first user's name, email address, phone number, and/or other identifier in order to allow the first user to have the other users in the first user's list of friends. Once another user becomes a first user's “friend,” the other “friend” user's digital media files may be viewed, in any manner and to an extent as determined by the other “friend” user, by the first user and vice versa. Thus, files may be communicated and shared amongst “friends,” according to each user's preference for sharing files. A user may control as many variables as the user wishes relating to the sharing of digital media files the user has associated with the user's account. Such control over the sharing of digital media files may be related to, by way of non-limiting examples, the digital media files' number, type, place/location, size, owner, genre, artist, content, user requester, and/or price.

According to another aspect of the present invention, a user may be able to direct the visual interface to a webpage that may access and show aspects of the user's account information, including, but not limited to, address, billing, and payment information and/or features, services, applications, functions, and/or capabilities the user has signed up to purchase and/or phone information, including, but not limited to, the user's phone's and user's devices' capabilities. The user may have the option of directing the visual interface to a website where the user can purchase another phone or other phone capabilities or connect to a user's device in order to transfer data or other information about that device. The user may have the option of directing visual interface to show sponsors' information and/or products and/or services. Furthermore, the user may have the option of changing any of his or her account information, as is necessary, and access further account maintenance features as may be understood by those of ordinary skill in the art.

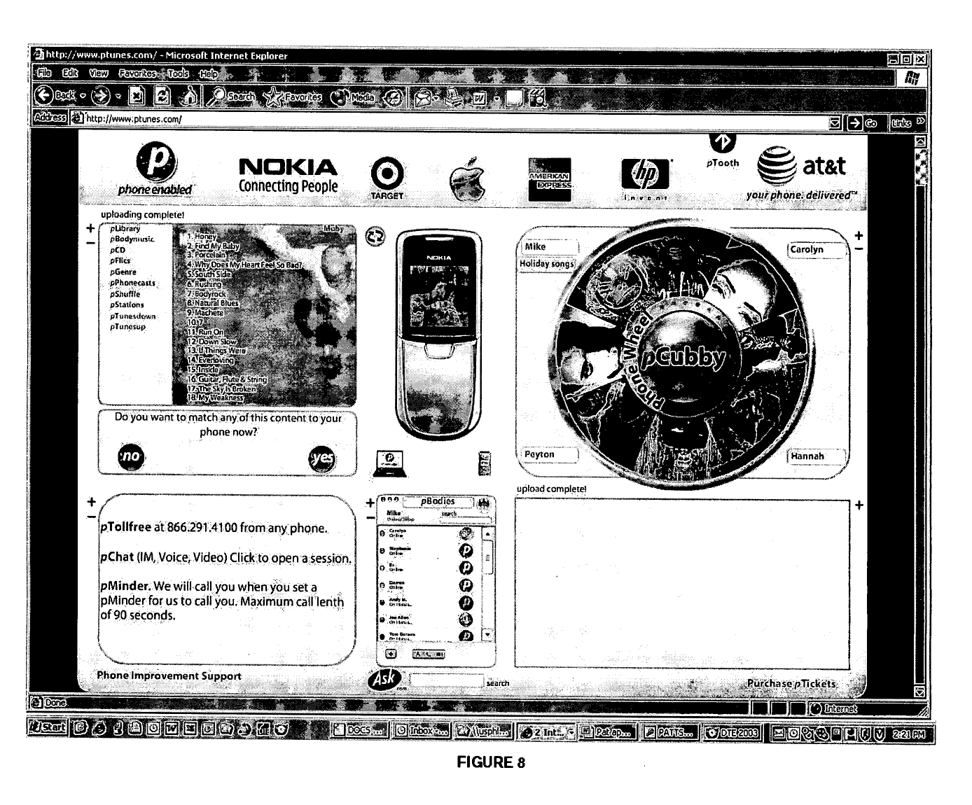

According to an aspect of the present invention, a user may be able to direct all or part of the visual interface to a help/support webpage or section of a webpage, in which a user may see information to allow the user to call, email, and/or send a voice recording to a support technician or administrator for any issues the user may be having, an example of which is illustrated in FIG. 8. Such help/support function may function as any available or as may be understood by those of ordinary skill in the art of website/computer application support. Furthermore, such help/support function may also give a user a list of generalized problem areas wherein the user may select to receive help. Such help may take the form of a set of instructions, a website to review, a phone number to call, a phone call from a help provider, and/or the ability for a user to schedule to receive a call from a help provider at a time and day that the user may choose.

As illustrated in FIG. 7, a variety of selectable features may be seen. A user may be able to direct all or part of the visual interface to display a specific device the user has selected or a default device, if the user has not selected a specific device. The visual interface may show a user all of his or her devices that the system currently has data on, information on, or connectivity to and may highlight the device the user has currently selected, such as different shading or an increase in size as compared to the other devices the user has associated with the user's account. In one embodiment, the visual interface may show the device the user has selected positioned in the center of a portion of the visual interface, wherein each of the other devices may be shown at the bottom and to the side of a portion of the visual interface, which is illustrated in the center section of FIG. 7. When a user directs the visual interface to select a different device associated with his or her account, this device that was formerly not selected may become larger and positioned in the center of a portion of visual interface 530, and the device that is now de-selected may become smaller and positioned at the bottom and to the side of a portion of the visual interface. Device icons may also rotate within designated spots of the visual interface, based on selections made by the user. When a user selects a device, a menu of options and information for that specific device may appear at another portion of the visual interface, which the user may select from and interact with the device therewith, as described herein above.

According to another aspect of the present invention, a user may be able to view in the visual interface his or her digital media file collection in a myriad of ways. For example, a user may be able to view a menu of options for viewing his or her digital media file collection, an example of which is illustrated in the upper left portion of FIG. 7, wherein such menu may contain, but not be limited to, titles for ways of viewing digital media files by who they belong to, genre, the CD they came from, the type of file, artist, date created, date recorded, date played, date stored, content, who they came from, title of album, and also no specific manner (for example, a random or alphabetical listing of all digital media files). When a user selects to view digital media files under one of these such menu options, a user may see in the visual interface any number of pieces of data related to each digital media file including, but not limited to, their names, artists, genres, albums, sizes, owners, and/or dates acquired and/or recorded. Users may have the option via the visual interface to change the data relating to any number of a user's digital media files, as described herein above, to allow the user to recategorize, organize, and/or personalize the user's digital media file collection.

Another way a user may view his or her collection of digital media files via the visual interface is through pictoral or graphical images related to a user's digital media files, an example of which is illustrated in the lower right portion of FIG. 7. Users may have the option of, when a specific digital music file of the user's is selected, viewing pictures, photographs, graphs, charts, text, artwork, and/or other visual media related to the selected digital media file, including, but not limited to, the digital media file's album cover, lyrics, cover art, liner notes, artist photographs, artist website, artist information, picturebooks, and/or anything else related to the digital media file. Such viewing of visual media via the visual interface may be accomplished as described above herein in system 10. Such visual media may be viewed almost just like a regular book would be viewed, as may be understood by those of ordinary skill in the art.

According to another aspect of the present invention, a user may be able to, in the visual interface, select an option to play any one of a user's digital media files, as may be understood by those of ordinary skill in the art of playing digital media files on a computing device. A user may have the option to edit such digital media files as the user may deem proper, including, but not limited to, adding a segment of recording, as may be understood by those of ordinary skill in the art. Furthermore, if the user's selected digital media file has visual media associated with it, such visual media may be displayed in any other portion or portions of the visual interface as a background display, creating a background, see-through overlay, or faint version of it. Additionally, a user may select one or more pieces of visual media to upload to a phone or other device which is associated with the user's account. With this feature, a user may view the digital media files' artwork, cover art, liner notes, and or other artwork or text on his or her phone, if that phone is capable of displaying such media.

According to another aspect of the present invention, via the visual interface, a user may display a user's selected or entire collection of digital music files in any manner wherein the album or CD artwork (or a partial amount of such artwork) related to the digital music file is displayed in any manner so as to make the selection of the album or CD easy or user-friendly. Such an example of such an arrangement on the visual interface is illustrated in the upper left portion of FIG. 7. Such visual display of artist, CD, and/or album information or visual media may, via the visual interface, be connected directly to the artist's, digital media file's producer's, and/or record label's website or websites. Such a connection would allow a user easy access to any information on the internet about the artist, producer, or record label, as the case may be.

Furthermore, a user may have a specific capability to connect to internet ticket sellers via the visual interface. While a user may have a digital media file selected, an icon or icons may appear in the visual interface which, if the user selects one or both, connects the user to an internet website selling tickets for events related to the artist associated with the digital media file that the user selected. Such ticket selling application may be created in another visual interface and allow the user to interact with the ticket seller and keep the user homepage visual interface open at the same time. An example of such an icon is illustrated at the lower right corner of FIG. 7. Such an icon may appear even if the user has not selected any one digital media file and, if the user selects the icon via the visual interface, the user may connect to an internet website which sells any kind of tickets.

According to another aspect of the present invention, a user may have a specific capability to connect to individual advertisers via the visual interface. While a user may be working in his or her user homepage visual interface, an icon or selectable advertisement may appear which, if the user selects one, the user may be connected to an internet website of that advertiser. Any sort of selected advertisement or icon, as understood by those in the art, may be used and may be located in various spots of the visual interface. Such advertisers may be those which the system administrator has negotiated with to appear on users' homepages as they use them and may be related or unrelated to digital media files users have. The advertising application may create another visual interface and allow the user to interact with the advertiser and keep the user homepage visual interface open at the same time. Selectable advertisements may be generally applied to all user homepages or may be specifically targeted to particular users, based on information collected or obtained by the present system or by third parties. An example of such displaying of such advertiser icons is illustrated in the upper portion of FIG. 7.

In another embodiment, a user may connect to an internet search engine when a user enters a query topic in a field in the visual interface. When a user enters a query, another visual interface may be created and allow the user to read a webpage or search results about the query. An example of such an icon is illustrated at the bottom of the middle portion of FIG. 7. Such an icon may appear even if the user has not selected any one digital media file and, if the user selects the icon via the visual interface, the user may connect to an internet website which sells any kind of tickets. The visual interface may also have separate links for any type of information related to selected music or artists.

A user may be able to view, in one portion of the visual interface, the digital media files that have been uploaded to the device selected in the visual interface and may be able to select to download selected digital media files to the specific device through icons on the visual interface representing such options. The digital media files may be the user's own digital media files or they may be digital media files that belong to another user who is in the user's list of friends. Furthermore, the digital media files a user may have associated with a user's account may have been acquired in any number of ways, as described above herein. A user may be able to, through icons on the visual interface representing such option, transfer any number of digital media files associated with the user's account to any one of the user's devices associated with the user's account. Such transfers may be completed in any manner the user may choose including, but not limited to, selecting digital media files individually or as a group or groups and may be selected by genre, friend, size, artist, keyword, date, content, location, and/or how acquired. The visual interface may allow a user to select and transfer digital media files in a user-friendly, artistic, and/or easy manner. Furthermore, a user may automatically connect to any one or more of several devices, as described herein above, and may determine what differences in digital media files the user's devices differ by, and/or may ask or prompt the user if the user wishes to transfer digital media files when differences are detected.

A user may have access to specialized karaoke files, as described herein above, on the visual interface. When a user selects from the user homepage the karaoke function, a user may play karaoke files, allowing the user to both hear the digital music file being played and view the lyrics at the same time via the visual interface. In addition, a user may, via the visual interface, enable a camera or picture of video recording mechanism of the device to either take a picture or make a digital video file while the karaoke files are being played. This may occur if such device has the ability to create recordings, such as either audio or both audio and video, and if it is a device which is accepted as associated with the user. Such device may also allow the user to obtain a timed countdown, including by not limited to five (5) seconds, to allow a user to prepare for the playing of the karaoke file. A user may then, when the karaoke files are finished playing, save the recorded picture or digital video file for later use, including, but not limited to, viewing, sending via email, or storing, in the same manner as any other digital file.

According to another aspect of the present invention, a user may record his or her voice and/or other sounds and/or make videos digitally, if the user has a device capable of performing such function and the device is one which is accepted as associated with the user. With such recordings made, a user may transfer the digital recordings via the visual interface and then attach such recordings or parts of the recordings to any other digital media file to create a customized digital media file. A user may save such customized digital media file via the visual interface. A user may also manipulate or control such customized digital media file as he or she may with other digital media files by categorizing, naming, sending, sharing, and/or transferring such digital media files. In another embodiment, the visual interface may allow a user to record a voice command, save the voice recording, select a saved voice recording, link the saved voice recording to a certain other saved or stored digital media file, transfer the voice recording to a user's phone such that when the user speaks the same voice command into the phone, the user may also view or listen to the digital media file that is linked to the voice recording. Voice commands may be used for activating or deactivating any of the features of the system as described above herein.

According to another aspect of the present invention, a user may have the ability through the visual interface to create phone ringtones from one or more of his or her digital media files. Such phone ringtones may be then used with the user's phone instead of a phone-supplied ringtone. To create a substitute phone ringtone from a digital media file, a user may select an icon on the visual interface for ringtone creation, select a digital media file in the user's collection, select to create the ringtone from the selected digital media file, save the newly created ringtone, and then select to upload the newly created ringtone to a device associated with the user's account.

In addition, a user may have the ability to create ring-back tones from one or more of his or her digital media files. Ring-back tones may be those tones that caller hears as he or she awaits an answer from the person the caller is calling. A user may select a digital media file from his or her collection as a ring-back tone and may then allow the user's callers to hear that ring-back tone if the user is being called and has not answered the phone yet.

The visual interface may also have a calendar application which a user may use just like a datebook or planner, as may be understood by those of ordinary skill in the art. Such a calendar application may have the ability for a user to view past and future calendar years, months, and days, and make and save appointments as a user desires. Furthermore, a user may have the option of selecting a feature to alert or remind the user of upcoming events, which may include selecting an option in the visual interface allow a user o call on the user's phone as an alert or reminder of an event. Such alert or reminder may also be accomplished through the visual interface as a visual or audio alert or reminder and a user may also select a specific digital media file to play during the alert or reminder.

A user may also be allowed to keep in contact in real-time with other users, friends, or other people through the use of chat room, email, and instant messaging applications. A user may, as described above herein, have one or more friends that may be associated with that user's account. According to an aspect of the present invention, a user, when using his or her user homepage in the visual interface, may view a list of his or her friends, which is illustrated in the middle bottom portion of FIG. 7. The list of friends may include only those users who a user selects to be the user's friends and those users selected who have accepted to be the user's friend. The list of friends in the visual interface may show such information including, but not limited to, which friends are currently using their own user homepages or on the internet,. which digital media files the friends are currently using, which friends are currently in a chat room or may be available to instant message, and which friends wish to share one or more digital media files with the user.

A friend of a user may offer to share a digital media file with a user, which may then signal the user, through the visual interface, that the friend wishes to share a digital media file with the user. The user may then opt to play the digital media file through the visual interface.

Shared files may or may not have play limitations, for example, a shared file may play only once and then becomes inaccessible after playing. The system may then optionally prompt the user to purchase the file via the system or via an external link to a retailer.

Furthermore, a user may be offered the use of a chat room, wherein a user may select to chat with any number of users or the user may select to chat with only users and/or friends. Such a chat room function may operate and be enabled by any means necessary as may be understood by those of ordinary skill in the art.

According to another aspect of the present invention, a user may be offered the use of an instant messaging application, wherein a user may write text and send it in real-time to other users. In this instant messaging application, a user may select to send and/or receive instant messages from any number of users or the user may select to send and/or receive instant messages only from users arid/or friends.

If another user which a user may wish to instant message is currently not logged on or is not using a computing device at all, then a user may write or prepare an instant message which, when a user chooses to send it, may be sent to the other user's phone or other receiving device to be stored until the other user is using his or her phone or receiving device. Such an instant messaging application may operate in real-time and be enabled by any means necessary as may be understood by those of ordinary skill in the art.

A user may also have the ability to send, store, and receive email messages by assigning a user an email address upon account creation or registration, as may be understood by those of ordinary skill in the art.

The visual interface may also be configured to carry out all functions, capabilities, applications, and operations using devices which enable personal area networks, which include, by way of a non-limiting example, wireless devices which communicate with other wireless devices by way of short-range radio frequencies. Such wireless communications application may operate in real-time and be enabled by any means necessary as may be understood by those of ordinary skill in the art.

According to another aspect of the present invention, a user may, by one or more means, rewarded for using applications. For example, such rewards application may be tied in to the use, purchasing, sharing, downloading, and/or uploading of digital media files. The visual interface may allow a user to purchase digital media files from an internet website to add to a user's digital media files collection. Such a rewards application may allow a user to accumulate points and/or money or other such rewards or prizes in relation to how many digital music files a user buys, shares, trades, uploads, downloads, plays, and/or keeps stored. In one embodiment, such a rewards system may allow a user to accumulate money which would be redeemable for digital media files from specific sellers or may be applied toward fees or charges or may be redeemable for other items. Such a rewards application may be enabled by any means as necessary that may be understood by those of ordinary skill in the art.

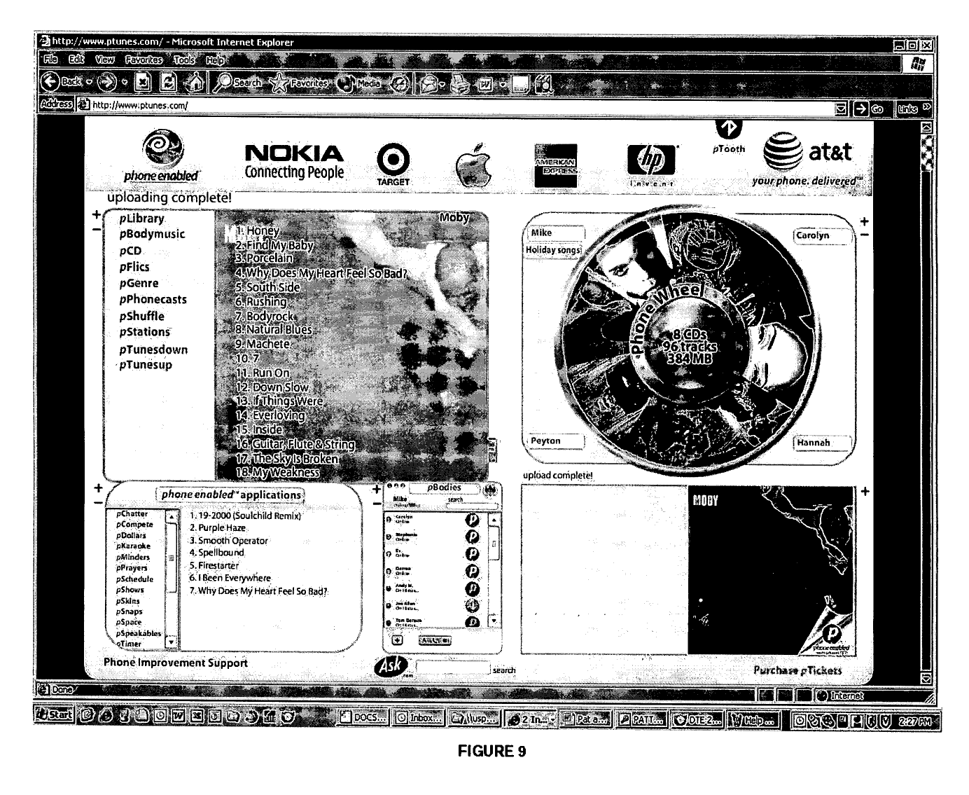

The visual interface may have the capability to make any section or sections of the visual interface, as described above herein, larger or maximized to fit the entire visual interface in order to allow a user to see any contents more easily, as may be understood by those of ordinary skill in the art of website development, an example of which is illustrated in the upper left portion of FIG. 9.

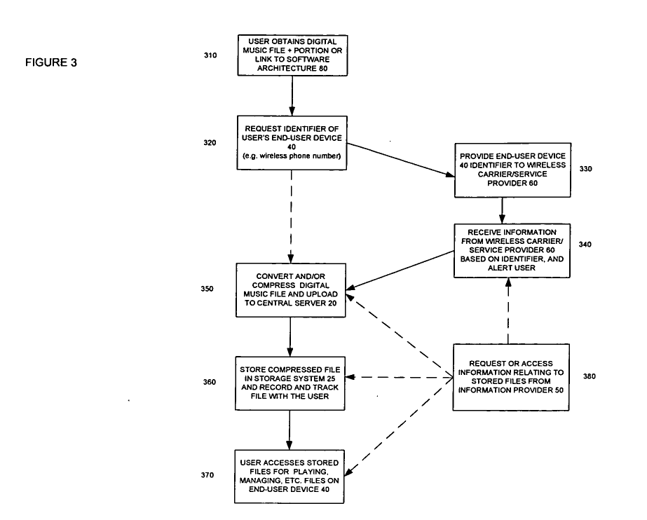

As mentioned previously, the present invention also includes a method 300 of managing and playing digital media files, and is illustrated generally in FIG. 3. For example, in step 310, a user may obtain at least one digital media file in the form of a music CD, having encoded thereon either a link to software 80 run on system 10, or all or any portion of software 80. The user may load or otherwise run the CD on upload station 30, which may be the user's home PC having a CD drive therein, for example, but which may also be any device capable of both reading all the files on the CD and connecting to wide area network 70. For example, upload station 30 may alternatively be the user's wireless phone, which the user may have used to purchase a digital music file online and downloaded to the storage resident on the wireless phone. Such digital music files may be obtained by the user in a multitude of ways such as, for example, purchasing the CD at a brick-and-mortar retail store, or downloading the digital music directly to upload station 30 via the internet from a website or on-line music store. In yet another example, a user may already own a tape, record, or digital file, and need simply to convert the file to a format suitable for use by system 10, and then either already have or separately obtain the necessary link to or portion of software 80, such as by separate download from the internet to upload station 30, or by separate purchase or gift from a retail store selling digital media, and subsequently loaded onto upload station 30.

At step 320, central server 20 may prompt the user for an identifier of the user's end-user device 40. If end-user device is the user's wireless phone, for example, such identifier could be, by way of non-limiting example, the phone number of the wireless phone. In this example, the wireless phone may be associated or otherwise have active service as separately contracted with a wireless phone service provider, designated herein as one of wireless carrier/service providers 60.

Next, at step 330, central server 20 may provide the identifier to wireless carrier/service provider 60 to obtain additional information relating to the type of phone identified by the user and the calling plan associated with that particular phone. Central server 20 may store this and any other collected information pertaining to the user in a separate user file. Upon receiving such additional information from wireless carrier/service provider 60 (regarding the user's phone, or end-user device 40), at step 340, central server 20 alerts the user at upload station 30 whether the user's phone is compatible with system 10. If the system is compatible, central server 20 may offer any form of payment or service plan for system 10, which may be accepted or denied by the user. If the user's phone is not compatible, central system 20 may provide to the user information regarding what can be done to make that phone and or calling plan compatible, make offers or suggestions to purchase a new phone and/or plan, or link in other third party retailers, such as other phone service carriers and phone manufacturers, who may advertise and/or make offers to the user via system 10 for selling products compatible with system 10.

Alternatively, method 300 may move directly from step 320 to step 350, and have steps 330 and 340 occur between steps 360 and step 370, described below.

At step 350, the user may upload the digital music file from upload station 30 to central server 20 via wide area network 70. This step may further include software 80 to convert and compress the digital music file into a format suitable for transfer and storage to central server 20. Alternatively, software 80 may instruct applications resident on upload station 30 to perform the necessary file conversion and compression.

Once the digital media file has been uploaded to central server 20, at step 360, central server 20 may identify, record and track the file in association with the user and other files previously stored, and optimize its usage of storage space in storage system 25 as described previously with regard to FIG. 2.

At a later point in time, in step 370, the user may connect to system 10 from end-user device 40 for accessing the user's digital media files previously uploaded to central server 20. As described previously, the user may be presented with a multitude of options, such as playing, organizing, creating or sending the digital media files and/or any other information relating to the digital media files. Such options may include, by way of non-limiting examples, to play or transfer the user's music via download, streaming, or remote accessing, buy additional music, create and/or store playlists of music, and/or organize music. It should be understood that because upload station 30 and end-user device 40 may be interchangeable, the user may, for example, perform these same options from a different device, such as his or her home PC, and create playlists or other file compilations for future access from the user's wireless phone. Also, as mentioned previously, central server 20 may alternatively perform steps 330 and 340 where the user connects to system 10 at end-user device 40. For example, the user may receive an alert from central server 20 that, while communication with system 10 occurs, some or all of the features of system 10 may not be compatible with the user's phone, and thus steps 330 and 340 may proceed as previously described, and lead into step 370.

At step 380, which may occur in conjunction with any of steps 330, 340, 350, 360, and 370, central server 20 may incorporate, either by request from the user or by software 80 recognition or logic, identify information related or complementary to stored digital media files and request such information from information provider 50. Such information may be requested, incorporated and/or selected for access by a user from end-user device 40. For example, upon request from a user at step 370, central server 20 may query information provider 50 for searchable news, information, recommendations, or lists associated with a particular digital media file, artist or any other feature selected by the user.

The above described method provides many points at which a user may be billed or otherwise charged a fee for use of system 10, although there is no requirement to charge any particular fees at particular points in method 300. For example, inclusion of separate programming or linking to software 80 may be independently chargeable at a point of sale, or may have a fee added to the manufacturing costs of CDs, or other portable storage of digital media. Additionally, fees may be assessed by central server 20 at step 330 or 340, as described above. Further, fees may be assessed and recorded in a User Account system, where usage of system 10 may be billed by any billing mechanism as understood by those skilled in the art. For example, payments for uploading or downloading media files may be transacted via known electronic financial transaction methods such as by credit card, debit card, or regular postal mail.

According to another aspect of the present invention, the uploaded digital media files may be used for more than easy listening. For example, any media file, such as a popular song or home recording, may be uploaded to a user's wireless phone and function as a ringtone. This system therefore provides vastly superior recordings of music or any other feature desired for a ringtone than compared to what may be commercially available.

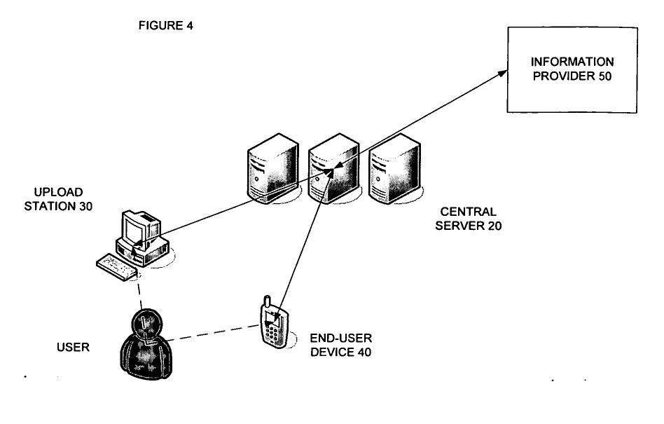

In another aspect of the present invention, a system and method of obtaining music files and data files relating to the music file is described. By way of non-limiting example, such a system 400 may be used for playing karaoke on end-user devices 40, and is illustrated in FIG. 4. For example, after a user has uploaded a digital music file from upload station 30 of a popular song for storage at central server 20, the user may, at end-user device 40, select “karaoke” from a set of selectable options provided through software 80, and further selecting the song identified for performing the karaoke. Upon selection of the song by the user, central server 20 either accesses or requests the lyrics of the selected song from information provider 50. Information provider 50 sends or allows access to a file corresponding to the lyrics, where such file may be in a format easily convertible or compatible with the song file held by central server 20. Information provider 50 may also provide a version of the song where there are no vocals, for combination with the lyrics file to better create the karaoke experience. Alternatively, information provider 50 may have specialized “karaoke files” in which the song and visual lyrics are prefabricated into a single file. Central server 20 may then prepare both the song file and the lyrics file in such a way that the user may access and play both files simultaneously, allowing the user on end-user device 40 to both play the song file and view the lyrics at the same time. This simultaneous play may occur as different functions running in multiple windows, or the files may be converted or otherwise merged together by central server 20 by any method understood by those skilled in the art, to form a new single and separate file playable from end-user device 40. Additionally, if end-user device is one that may create recordings, such as either audio or both audio and video, the user may record the karaoke, meaning the song and user's voice overlay, and subsequently upload the recording to central server 20 in the same manner as previously described herein.

In another aspect of the present invention, users may be able to hear a ringtone that is unique to a specific caller. Such ringtone may only be heard when a specific caller calls a user on his/her phone and may serve as a type of caller identification for the user. Such ringtone may be selected by the user and linked to a specific phone number such that, when a call with that specific phone number comes in, a user may hear the ringtone associated with that caller.

In addition to the different upload stations 30 previously described, users may also use a laptop phone (or other computing device which allows and is configured for voice over internet protocol (VoIP) communications), as an upload station. The VoIP may function as understood by those having ordinary skill in the art.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

1. A system for managing digital media data files, owned by a user, over a network, comprising:
at least one processor;
at least one database, communicatively connected to said at least one processor, for storing at least one data file;
at least one computing device, remote from said at least one processor and communicatively connected to said at least one processor via the network, wherein said at least one computing device is capable of uploading said at least one data file and subsequently managing selected ones of said at least one data file, wherein said user provides a first information item relating to an accessibility of said at least one computing device to said at least one processor;
at least one service provider, remote from said at least one processor and communicatively connected to said at least one processor via said network, wherein said at least one service provider provides a second information item, relating to a capability of said at least one computing device in accordance with said first information item, to said at least one processor;
at least one interactive visual interface wherein said user manages and views, in real-time and in conjunction with said system, at least one selected from the group consisting of: user's said digital media files, said data files, said information items; and combinations thereof; and
wherein said at least one processor allows remote access to certain of said selected ones of said at least one data file by said at least one computing device based substantially on said first and second information items.

2. The system of claim 1, wherein said at least one computing device comprises a wireless phone.

3. The system of claim 2, wherein said first information item is a phone number.

4. The system of claim 2, wherein said at least one information provider is a wireless phone carrier providing service to said wireless phone.

5. The system of claim 1, wherein said at least one data file provides instructions to said at least one computing device to link to said at least one processor via said network.

6. The system of claim 1, wherein said at least one data file comprises an audio file.

7. The system of claim 1, further comprising a second information provider, wherein said second information provider provides information, via said network, relating to at least one of said at least one data files to said at least one processor and subsequently accessible by said at least one computing device from said at least one processor.

8. The system of claim 7, wherein said information provided by said second information provider comprises advertising material.

9. The system of claim 1, wherein said interactive visual interface displays at least one selected from the group consisting of: text, photographs, pictures, animated content, artwork, graphs, charts, and combinations thereof.

10. The system of claim 1, wherein said at least one user must pay for using said system before using said system.

11. The system of claim 2, wherein said wireless phone plays a ring-back tone when a call is placed to said wireless phone.

12. The system of claim 1, wherein said interactive visual interface allows at least one user to perform at least one selected from the group consisting of: communicate via instant message with at least one other user, communicate via a chat room with at least one other user, send emails to at least one other user, share digital media data files with at least one other user, obtain data in real-time about at least one other user, view at least one data file of at least one other user, and combinations thereof.

13. The system of claim 1, wherein all contents of said interactive visual interface are modified by said user to create different views of said contents.

14. The system of claim 1, wherein said interactive visual interface allows said user to view information about at least one said digital media file in different ways.

15. The system of claim 1, wherein said interactive visual interface is capable of displaying said second information in conjunction with said user's said digital media files.

16. The system of claim 1, wherein said interactive visual interface is capable of directing said user to one selected from the group consisting of: advertisers' websites, ticket sellers' websites; artists' websites; and combinations thereof.

17. The system of claim 1, wherein said interactive visual interface allows said user to create a digital media file and store said created digital audio file in said database of said system.

18. The system of claim 1, wherein said interactive visual interface allows said user to edit at least one of said user's said digital media files.

19. The system of claim 1, wherein said interactive visual interface allows said user to manage said user's said digital media files residing on at least one of said user's said at least one computing device.

20. The system of claim 1, wherein said interactive visual interface allows said user to manage at least one property of said user's said at least one computing device.

21. A method of managing digital media data files over a network, comprising:
providing a first information item relating to at least one computing device to at least one processor located remotely from said at least one computing device via a network;
uploading, via said network, at least one data file from said at least one computing device to said at least one processor;
requesting, by said at least one processor via said network, a second information item relating to said at least one computing device and based on said first information item, from an information provider;
downloading selected ones of said at least one data file based by said at least one computing device, wherein said at least one processor manages said downloading and other accessing by said at least one computing device based on said first and second information items;
providing at least one interactive visual interface which allows a user of said method to carry out all functions of said method in real-time.

22. The method of claim 21, wherein said at least one computing device comprises a wireless phone.

23. The system of claim 22, wherein said wireless phone plays a ring-back tone when a call is placed to said wireless phone

24. The method of claim 22, wherein said first information item is a phone number.

25. The method of claim 22, wherein said at least one information provider is a wireless phone carrier providing service to said wireless phone.

26. The method of claim 21, wherein said at least one data file provides instructions to said at least one computing device to link to said at least one processor via said network.

27. The method of claim 21, wherein said at least one data file comprises an audio file.

28. The method of claim 21, further comprising requesting, by said at least one processor via said network, a third information item relating to at least one of said at least one data file, from a second information provider, wherein said at least one processor provides access to said third information item to said at least one computing device.

29. The method of claim 28, wherein said third information item provided by said second information provider comprises advertising material.

30. The method of claim 28, wherein said third information item provided by said second information provider is at least one selected from the group consisting of: text, photographs, pictures, animated content, artwork, graphs, charts, and combinations thereof.

31. A system for displaying lyrics to prerecorded music during play of the prerecorded music via a network, comprising:
at least one processor and at least one database, communicatively connected to said at least one processor, for storing a plurality of prerecorded music files;
at least one information provider, remote from said at least one processor and communicatively connected to said at least one processor via a network, wherein said at least one information provider provides at least lyrics corresponding to selected ones of said plurality of prerecorded music files at the request of said at least one processor;
at least one computing device, remote from said at least one processor and communicatively connected to said at least one processor via a network, wherein said at least one processor provides access to selected ones of said plurality of prerecorded music files and said corresponding lyrics for both playing said selected ones of said plurality of prerecorded music files and viewing said corresponding lyrics simultaneously on said at least one computing device; and
at least one interactive visual interface wherein a user may, in real-time and in conjunction with said system, carry out all functions of said system.

32. The system of claim 31, wherein said at least one computing device comprises a wireless phone.
